(19) United States
(12) Patent Application Publication
(10) Pub. No.: US 2024/0068467 A1
(43) Pub. Date: Feb. 29, 2024

(54) SOFT SERVE ICE CREAM PUMP ASSEMBLY

(71) Applicant: Plum Creek Farm LLC, Bernville, PA (US)

(72) Inventor: Keith Zimmerman, Leesport, PA (US)

(21) Appl. No.: 17/386,053

(22) Filed: Jul. 27, 2021

(51) Int. Cl. F04B 53/10; A23G 9/20; A23G 9/22

(52) U.S. Cl. CPC F04B 53/10; A23G 9/20; A23G 9/22; F16K 15/147

(57) ABSTRACT

A pump assembly including a pump structure defining a mixture inlet extending to a mixture outlet opening into a receiving chamber and an air inlet extending to an air outlet opening into an air chamber defined between the pump structure and a piston supported on and movable relative to pump structure. A pressurized fluid tube extends through the pump structure from a pressure inlet in fluid communication with the receiving chamber to a pressure outlet within a pressure chamber which is communication with an outlet port. An air tube extends through the pump structure from the air chamber to an air outlet within the pressure chamber. Each stroke of the piston causes pressurized liquid mixture and air to be passed into the pressure chamber and to the outlet port. A flexible, one-way valve is positioned on each of the mixture outlet, the pressure outlet and the air outlet.

### FIELD OF THE DISCLOSURE

The present disclosure relates to soft serve ice cream machines. More particularly, the disclosure relates to pump assemblies utilized with soft serve ice cream machines.

### BACKGROUND

In the mechanical production of ice cream and other frozen dessert products, an ice cream mix is normally combined with a non-toxic gas such as air in order to produce a tasteful, palatable and profitable end product. For soft serve ice cream, the air content can vary from 0% to 60% of the total volume of the finished product. The amount of air alters the taste of the finished product. Product with low quantities of air has a heavy, icy taste while product with higher air content tastes creamier, smoother and lighter. The optimum quantity of air is determined by the other ingredients and individual taste. In general, the preferred air content is between 30% and 45% of volume.

The soft serve ice cream liquid mix is kept preserved at the ideal temperature in a tank (stainless steel or other material) that is refrigerated and controlled by a thermostat. The ice cream mix remains there until it is delivered by means of gravity or a pump into the freezing chamber where it is intimately mixed with the targeted quantity of air, stirred, and quickly frozen to obtain a soft serve ice cream.

An important reason for a machine to have a pump is to increase the volume of the ice cream by adding air to the ice cream mix. This affects the machine in two ways: First, it reduces the amount of mix in a given volume of ice cream, which increases the output of the machine per hour; and, secondly, it decreases the density of ice cream, and thus increases ice cream “softness” creating a sensation that it is less cold to the palate.

Under ideal working condition, the pump delivers a constant, perfect supply of liquid mix and gas (usually air) to the freezing chamber in a predetermined ratio between air and liquid mix. However, the pump may not work under expected ideal condition due to clogging or the like in the pump.

### SUMMARY

In at least one embodiment, the present disclosure provides a pump assembly including a pump structure defining a mixture inlet extending to a mixture outlet opening into a receiving chamber and an air inlet extending to an air outlet opening into an air chamber defined between the pump structure and a piston supported on and movable relative to pump structure. A pressurized fluid tube extends through the pump structure from a pressure inlet in fluid communication with the receiving chamber to a pressure outlet within a pressure chamber which is communication with an outlet port. An air tube extends through the pump structure from the air chamber to an air outlet within the pressure chamber. Each stroke of the piston causes pressurized liquid mixture and air to be passed into the pressure chamber and to the outlet port. A flexible, one-way large slot valve is positioned on each of the mixture outlet, the pressure outlet and the air outlet. The valves are tolerant to small particles in the liquid mix (like strawberry seeds, fruit pieces, etc) which greatly extends the types and flavors of liquid mix that can be used to make soft serve ice cream. The valve design also tolerates a significant amount of butterfat buildup without reducing its effectiveness as a one-way valve.

In at least one embodiment, the use of flexible, one-way large slot valves for pumping liquid mix and air reduces that complexity and number of parts associated with a piston pump. This enhancement provides benefits by reducing the cost of manufacturing the pump and it simplifies the routine cleaning procedure for the operator because there are less parts to disassemble, clean and reassemble.

In at least one embodiment, a stem with a barb is located on each of the liquid mix inlets, the liquid mix outlet and the air outlet. During assembly, the valves are slid over the stem and the barb serves as a retainer during operation. When the pump needs to be disassembled for cleaning, the stem and barb design allows the operator to gently tug on the duckbill valves to remove them so the internal porting of the pump body can be cleaned.

In at least one embodiment, a stem with a barb is located on both liquid mix ports, the liquid mix outlet port and the air outlet port. This stem design provides support for the duckbill valve preventing it from inverting or tearing when the pressure from the pump piston is applied to it. This support system greatly extends the life of the duckbill valve and increases the effectiveness of the one-way function of the valve.

In at least one embodiment, the air inlet check valve is located externally of the pump body. Removing the air inlet valve from the moist and harsh conditions present in the internal workings of the pump increases the long-term reliability of the air inlet valve and reduces the possibility of loss of function because of butterfat contamination.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is an isometric view of an ice cream machine with the hopper cover removed to show an illustrative pump within the hopper.

FIG. 2 is an isometric view of a pump in accordance with an embodiment of the disclosure.

FIG. 3 is an isometric view of the pump of FIG. 2 with the housing and piston removed.

FIG. 4 is a cross-sectional view along the line 4-4 in FIG. 2, with the housing removed.

FIG. 5 is a cross-sectional view similar to FIG. 4 with the housing in place and the suction tube removed.

FIG. 6 is a cross-sectional view along the line 6-6 in FIG. 3 showing the mixture intake tubes within the pump body.

FIG. 7 is a cross-sectional view along the line 7-7 in FIG. 3 showing the mixture and air delivery tubes within the pump body.

FIG. 8 is a cross-sectional view along the line 8-8 in FIG. 3 showing the air intake tube within the pump body.

FIG. 9 is an isometric view of an illustrative valve member.

FIG. 10 is an end view of the valve member of FIG. 9.

FIG. 11 is a cross-sectional view through the valve member of FIG. 9.

FIG. 12 is an isometric view of a pump in accordance with another embodiment of the disclosure.

FIG. 13 is an isometric view of the pump of FIG. 12 with the housing removed.

FIG. 14 is an isometric view of the pump body of the pump assembly of FIG. 12.

FIG. 15 is a cross-sectional view along the line 15-15 in FIG. 13 showing the mixture intake tubes.

FIG. 16 is a cross-sectional view along the line 16-16 in FIG. 13 showing the mixture and air delivery tubes.

FIG. 17 is a cross-sectional view along the line 17-17 in FIG. 13 showing the outlet tube.

FIG. 18 is a cross-sectional view of along the line 18-18 in FIG. 13 showing the air intake tube.

### DETAILED DESCRIPTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

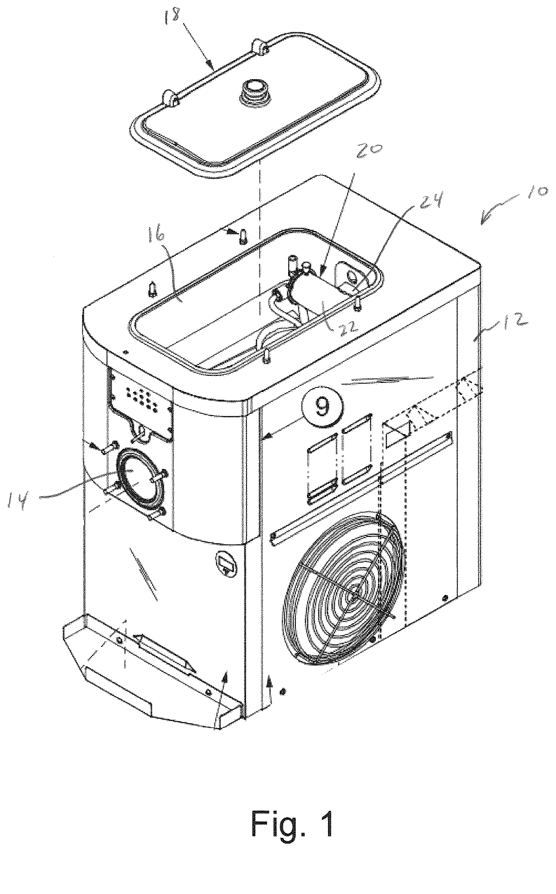

Referring to FIG. 1, an illustrative ice cream machine 10 is shown. The ice cream machine 10 generally includes a housing 12 which supports a freezing chamber 14 and a hopper 16, along with other components for operating the machine. The liquid mixture (not shown) is added to the hopper 16 and then the hopper cover 18 is placed on the hopper 16. The hopper 16 is configured to maintain the liquid mixture at a desired temperature before it is delivered to the freezing chamber 14. A pump assembly 20 is positioned within the hopper 16 and is configured to combine the liquid mixture with a gas (typically air) and to deliver the liquid/gas mixture to the freeze chamber 14 at a desired pressure. While the pump assembly 20 is shown positioned within the hopper 16, it is understood that the pump assembly 20 may be positioned outside of the hopper. A drive shaft (not shown) extends into the pump assembly 20 through a shaft opening 24 and is configured to drive the pump assembly piston 90, as will be described in more detail hereinafter.

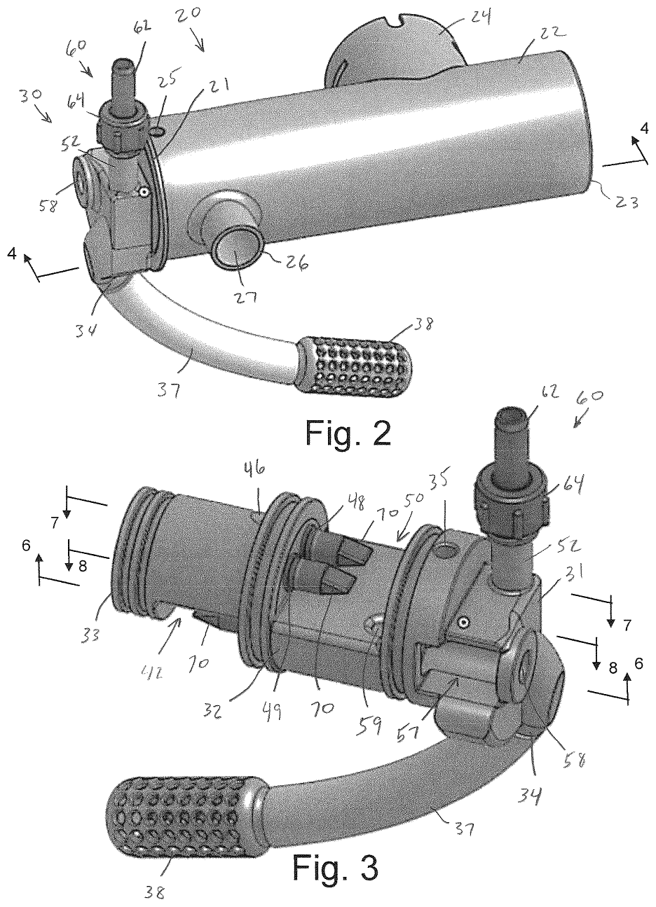

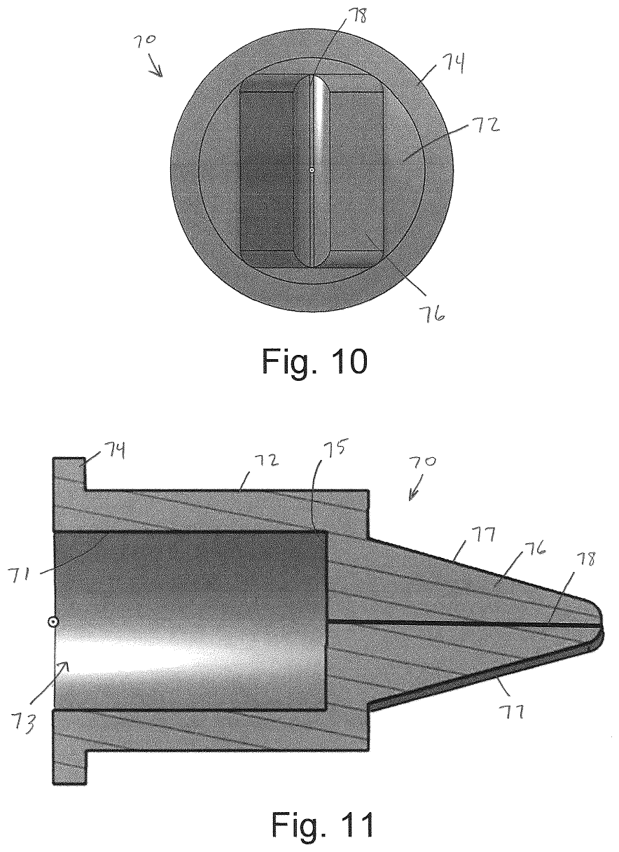

Referring to FIGS. 2-11, a pump assembly 20 in accordance with an embodiment of the disclosure will be described. The pump assembly 20 generally includes a pump housing 22, a pump body 30 and a piston 90. The pump housing 22 is a generally open tubular structure extending from a first end 21 to a second end 23. The shaft opening 24 opens into the pump housing 22 towards the second end 23 such that the drive shaft (not shown) aligns with and engages the piston 90. An outlet port 26 extends from the pump housing 22 proximate the first end 21 such that an outlet tube 27 of the outlet port 26 is in fluid communication with a pressure chamber 50 defined by the pump body 30, as will be described hereinafter. Coaxial passages 25, 35 extend through the housing 22 and pump body 30 such that a locking pin (not shown) may be positioned thereto to lock the pump housing 22 to the pump body 30.

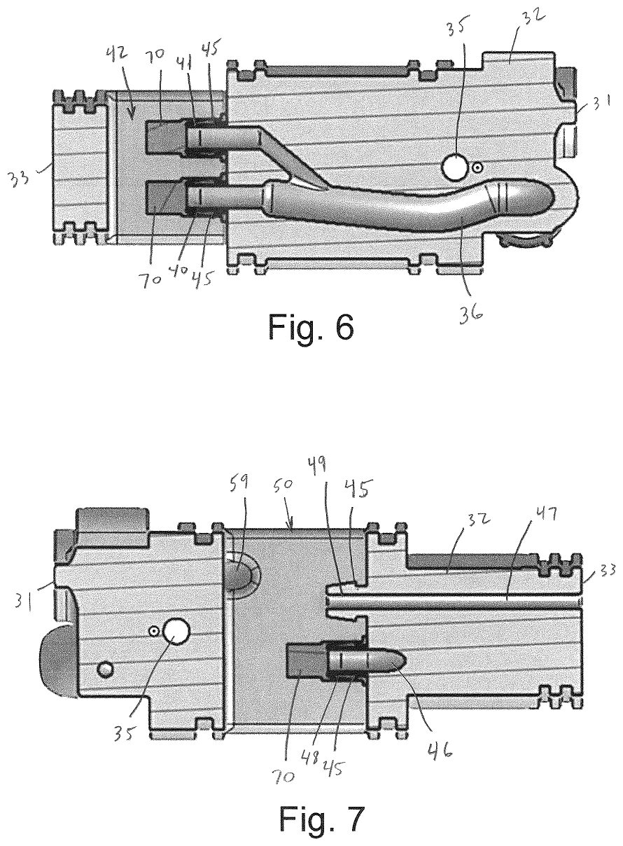

The pump body 30 has a solid body 32 extending from a first end 31 to a second end 33. Various chambers and tubes are defined within the solid body 32, as will be described. The body 32 also defines a plurality of o-ring slots configured to hold o-rings for sealing between the pump body 32 and the housing 22 and the pump body 30 and the piston 90. The o-rings are omitted in the drawings. The body 32 defines a mixture inlet 34 with a mixture inlet tube 36 extending from the inlet 34 to a pair of outlets 40, 41 (see FIG. 6). In the illustrated embodiment, a suction hose 37 and inlet screen 38 are connected to the inlet 34. The inlet 34 includes a radial barb 39 configure to engage and retain the suction hose 37, but allow for easy removal and reconnection during cleaning. The suction hose 37 extends into the liquid mixture within the hopper 16, which passes through the inlet screen 38 before being sucked into the pump assembly 20. The outlets 40, 41 are in fluid communication with a receiving chamber 42 defined between the pump body 30 and the housing 22. A flexible, one-way valve 70 is positioned on each of the outlets 40, 41, and only allow fluid flow in the direction from the mixture inlet tube 36 to the receiving chamber 42. As seen in FIG. 5, each of the outlets 40, 41 has a radial barb 45 extending thereabout (see FIG. 7 showing the air outlet without the valve positioned thereon such that the barb 45 is clearly visible). The barb 45 engages an inside surface of the one-way valve 70 to retain the valve 70 in position but allows the valve 70 to be easily removed and replaced during cleaning.

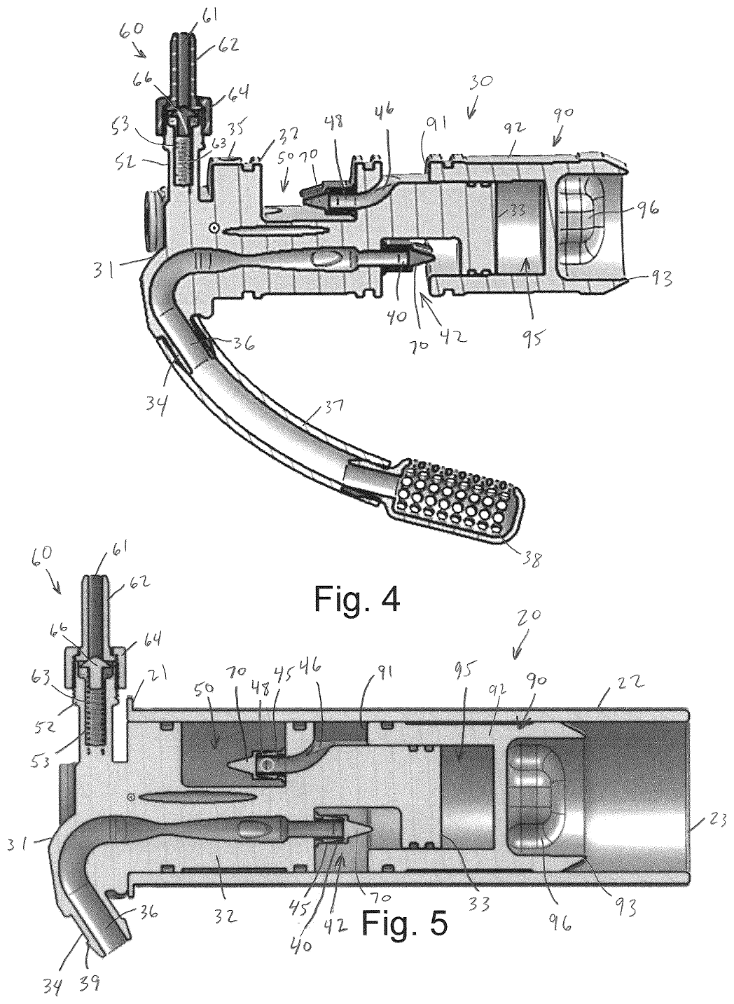

Referring to FIGS. 4 and 5, the piston 90 includes a piston body 92 with an open end 91 configured to receive and slide along the second end 33 of the pump body 30. An air chamber 95 is defined between the internal surface of the piston 90 and the pump body end 33. A receiving detent 96 is defined proximate the opposite end 93 of the piston body 92. The receiving detent 96 receives a caming member on the drive shaft. As the drive shaft rotates, the caming member moves in the receiving detent 96 which causes the piston 90 to move toward and away from the pump body 30. The piston 90 extends about the second end 33 of the body 32. As such, the piston 90 seals between the pump body 30 and the housing 22, thereby confining the receiving chamber 42. Referring to FIG. 4, as the piston 90 moves away from the pump body 30 as indicated by arrow A, a vacuum is created in the receiving chamber, thereby causing liquid mixture to be drawn in through the mixture inlet 34.

As seen in FIG. 5, the receiving chamber 42 is in fluid communication with a pressure tube 46 which extends to a pressure outlet 48 within the pressure chamber 50. A flexible, one-way valve 70 is positioned on the pressure outlet 48 and only allows fluid flow in the direction from the pressure tube 46 to the pressure chamber 50. The pressure outlet 48 includes a radial barb 45 configured to retain the valve 70. When the piston 90 moves in the direction of arrow A, the vacuum force impacts only the mixture inlet 34 and not the pressure chamber 50. When the piston 90 moves toward the pump body 30 as indicated by arrow B, the liquid mixture with the receiving chamber 42 is pressurized and driven through the pressure tube 46 and into the pressure chamber 50. The valves 70 on outlets 40, 41 prevent pressurized fluid from passing to the inlet tube 36 and all of the pressurized fluid is delivered to the pressure chamber 50.

In addition to the liquid mixture, air is also provided to the pressure chamber 50 and mixed with the pressurized fluid. Referring to FIGS. 4, 5, 7 and 8, the body 32 defines an air inlet 52 with an air tube 53 which extends from the air inlet 52 through the body 32 to second end 33 thereof in communication with the air chamber 95. In the illustrated embodiment, a check valve 60 is connected to the air inlet 52. In the illustrated embodiment, the check valve 60 includes an inlet portion 62 defining an air inlet tube 61. The inlet portion 62 is retained on the air inlet 52 via a threaded connection member 64. A spring 63 and poppet member 66 are positioned within the air tube 53 and inlet portion 62 such that the spring 63 biases the poppet 66 into sealing engagement of the air inlet tube 61. As such, the check valve 60 only allows air to pass into the air inlet 52, but the poppet 66 prevents air from flowing the in the opposite direction. When the piston 90 is moved in the direction of arrow A, air is drawn through the check valve 60 and air tube 53 and into the air chamber 95. The inlet portion 62 of the check valve preferably extends to a height such that the air inlet tube 61 opens above the level of mixture in the hopper 16. Additionally, the threaded connection member 64 allows the check valve 60 to be easily removed and disassembled for cleaning. Removing the air inlet valve 60 from the moist and harsh conditions present in the internal workings of the pump increases the long-term reliability of the air inlet valve and reduces the possibility of loss of function because of butterfat contamination.

When the piston 90 moves in the direction of arrow B, the air in the air chamber 95 is pushed through an air tube 47 through the body 32 to an air outlet 49 which opens into the pressure chamber 50. A flexible, one-way valve 70 is positioned on the air outlet 49 and only allows fluid flow in the direction from the air chamber 95 to the pressure chamber 50. The air outlet 49 includes a radial barb 45 configured to retain the valve 70. When the piston 90 moves in the direction of arrow A, the vacuum force impacts only the air inlet 52 and not the pressure chamber 50. When the piston 90 moves in the direction of arrow B, the air with the air chamber 95 is driven through the air tube 47 and into the pressure chamber 50.

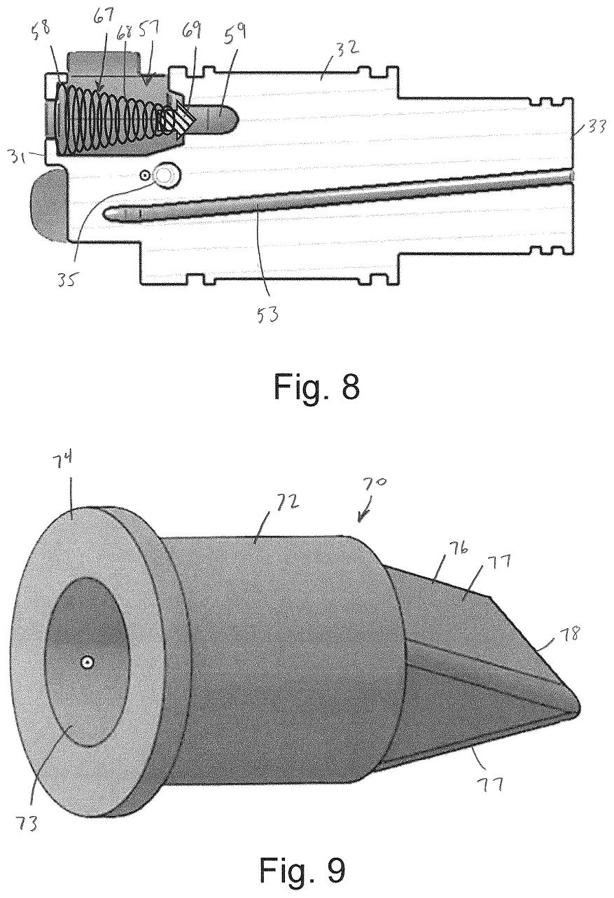

With each stroke of the piston 90, a combination of pressurized liquid and air to enter the pressure chamber 50. The pressure chamber 50 is in fluid communication with the outlet tube 27 of the outlet port 26. As such, the pressurized liquid/air mixture is delivered to the outlet port 26 from which it is delivered to the freezing chamber via a tube (not shown). Referring to FIG. 8, a pressure relief valve 67 is positioned in a pressure relief chamber 57 defined by the body 32 and opening along an external wall of the body 32. The pressure relief valve 67 includes a spring 68 and a poppet 69. The spring 68 is positioned with one end abutting a seat 58 along one end of the chamber 57 and extends about a portion of the poppet 69 which sealingly engages the relief passage 59. The relief passage 59 extends between the pressure chamber 50 and the pressure relief chamber 57. In the event the pressure within pressure chamber 50 is larger than a desired pressure, the spring 68 will be caused to compress, such that the poppet 69 moves from sealing engagement and the mixture flows through the pressure relief chamber 57 and back into the hopper 16. The position of the pressure relief chamber 57 along an outer surface of the body 32 allows for easy removal and cleaning of the pressure relief valve 67.

Referring to FIGS. 9-11, an illustrative flexible valve 70 will be described. Each of valves 70 has a tubular body 72 with an opening 73 extending thereinto from one end. A flange 74 extends about the open end. The open area within the tubular body 72 includes a side wall 71 and an end wall 75. The size of the open area is preferably such that the inlets and outlet tubes sit within the open area in contact with the side wall 71 and end wall 75, with the barb 45 pressing into the side wall 71. With this configuration, the inlet/outlet tubes provide support for the valve 70, preventing it from inverting or tearing when the pressure from the pump piston is applied to it. This support system greatly extends the life of the valve and increases the effectiveness of the one-way function of the valve.

The opposite end of the valve 70 includes a generally solid portion 76 with tapered opposed walls 77. A sealed slot 78 extends through the generally solid portion 76. This valve configuration may be referred to as a duckbill valve, however, other one-way valve configurations with a large slot opening may be utilized. With the tapered wall 77 configuration, force directed from the solid end toward the valve causes the slot 78 to be forced into a sealed condition. When a force passes through the opening 73, the force causes the walls 77 to move apart and opens the slot 78 to open. The flexible nature of the valve 70 and the wide slot 78 allows the valves to be tolerant to small particles in the liquid mix (like strawberry seeds, fruit pieces, etc) which greatly extends the types and flavors of liquid mix that can be used to make soft serve ice cream. The duckbill valve design also tolerates a significant amount of butterfat buildup without reducing its effectiveness as a one-way valve.

The use of flexible, one-way valves with a large slot opening for pumping liquid mix and air reduces that complexity and number of parts associated with a piston pump. This enhancement provides benefits by reducing the cost of manufacturing the pump and it simplifies the routine cleaning procedure for the operator because there are less parts to disassemble, clean and reassemble.

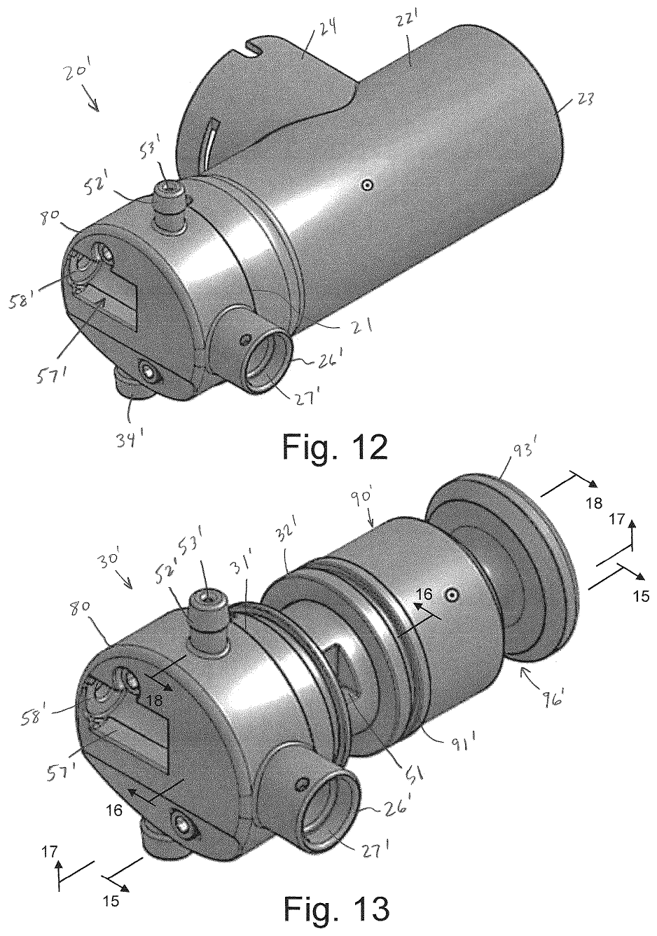

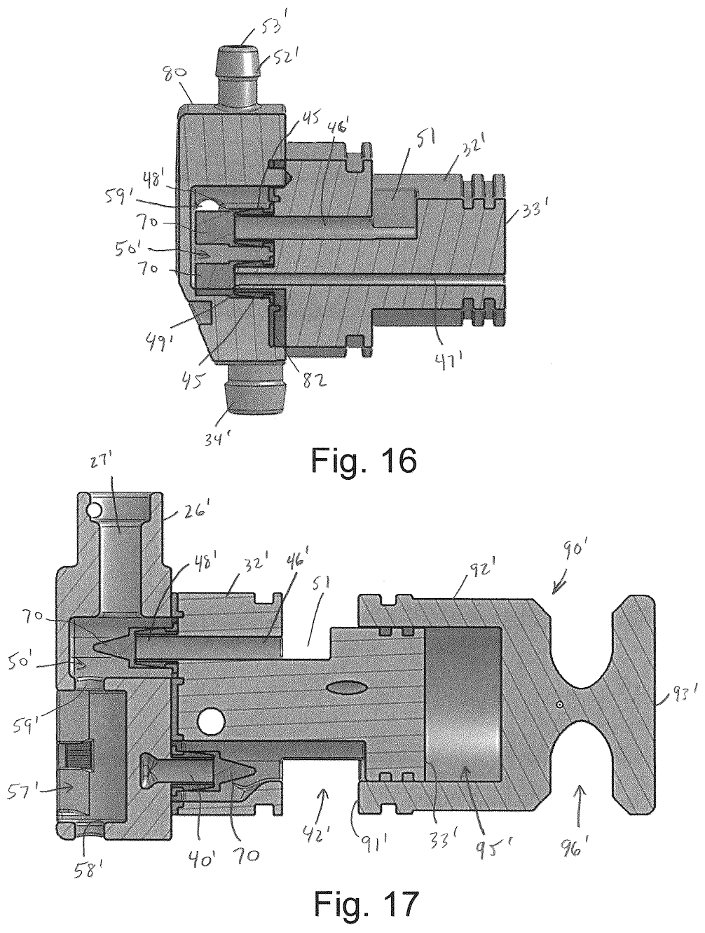

Referring to FIGS. 12-18, a pump assembly 20′ in accordance with another embodiment of the disclosure will be described. The pump assembly 20′ is similar to the previous embodiment and only the differences will be described. The pump assembly 20′ generally includes a pump housing 22′, an outlet flange 80, a pump body 30′ and a piston 90. The pump housing′ 22 is substantially similar to the previous embodiment, however, the outlet port 26′ is defined in the outlet flange 80 instead of the housing 22′. The housing 22′ is also shorter between the ends 21, 23 to complement the shorter pump body 30′, as will be described.

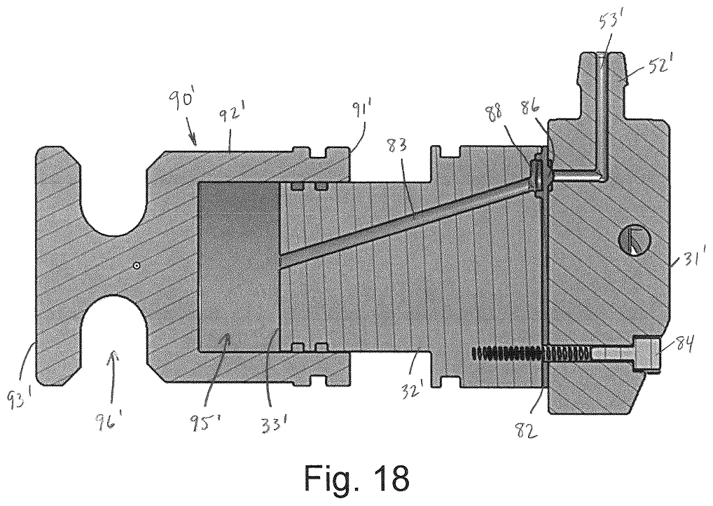

The pump body 30′ has a solid body 32′ extending from a first end 31′ to a second end 33′. The body 32′ is shorter than in the previous embodiment as the pressure chamber 50′ is defined in the outlet flange 80. The outlet flange 80 is connected to the pump body 30′ via screws 84 or the like (see FIG. 18). A sealing gasket 82 preferably is positioned between the outlet flange 80 and the pump body 30′. The mixture inlet 34′ and mixture inlet tube 36′ are defined in the outlet flange 80. The mixture inlet tube 36′ extends to a pair of outlets 40′, 41′ (see FIG. 15). The outlets 40′, 41′ extend into a passage 43 within the pump body 30′ which is in communication with the receiving chamber 42′. A flexible, one-way valve 70 is positioned on each of the outlets 40, 41, and only allow fluid flow in the direction from the mixture inlet tube 36′ to the receiving chamber 42′. Each of the outlets 40′, 41′ includes a radial barb 45 configured to retain the valve 70.

A pressure tube 46′ extends from an opening 51 in the body 32′ which is in communication with the receiving chamber 42′. The pressure tube 46′ extends to a pressure outlet 48′ within the pressure chamber 50′ withing the outlet flange 80. A flexible, one-way valve 70 is positioned on the pressure outlet 48′ and only allows fluid flow in the direction from the pressure tube 46′ to the pressure chamber 50′. The pressure outlet 48 includes a radial barb 45 configured to retain the valve 70. When the piston 90 moves in the direction of arrow A, the vacuum force impacts only the mixture inlet 34′ and not the pressure chamber 50′. When the piston 90 moves toward the pump body 30′ as indicated by arrow B, the liquid mixture with the receiving chamber 42′ is pressurized and driven through the pressure tube 46′ and into the pressure chamber 50′. The valves 70 on outlets 40′, 41′ prevent pressurized fluid from passing to the inlet tube 36′ and all of the pressurized fluid is delivered to the pressure chamber 50′.

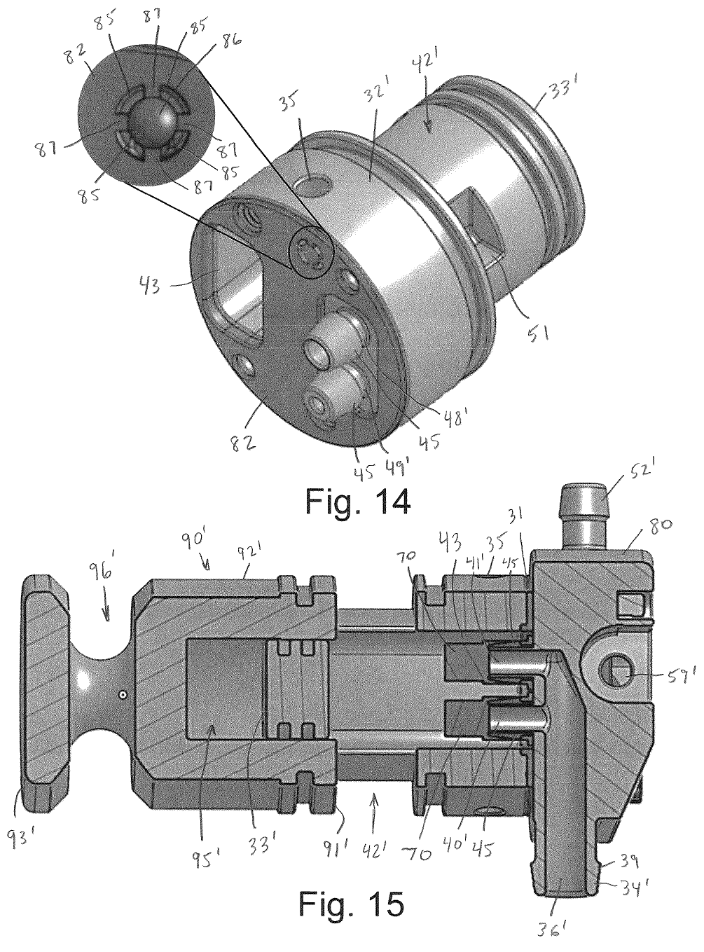

In addition to the liquid mixture, air is also provided to the pressure chamber 50′ and mixed with the pressurized fluid. Referring to FIGS. 14, 16 and 18, the outlet flange 80 defines an air inlet 52′ with an air tube 53′ which extends from the air inlet 52′ to a continuing air tube 83 extending through the body 32′ to second end 33′ thereof in communication with the air chamber 95. A check valve 86 is defined by the gasket 82 and is positioned between the air tube 53′ and the continuing air tube 83. As shown in FIGS. 14 and 18, a series of openings 85 are defined about the check valve 86 such that the check valve 86 is supported by a plurality of spaced apart arms 87. The check valve 86 is flexibly supported by the gasket 82 and is configured to move into sealing engagement with he air tube 53′ when pressure is delivered through the continuing air tube 83. As seen in FIG. 18, the check valve 86 has a domed configuration on the side facing the air inlet 53′ while a larger open area 88 is defined at the opening into the continuing air tube 83. As such, the check valve 86 sealingly engages the air tube 53′ but not the continuing tube 83.

When the piston 90 moves in the direction of arrow B, the air in the air chamber 95 is pushed through an air tube 47′ through the body 32′ to an air outlet 49′ which opens into the pressure chamber 50′. A flexible, one-way valve 70 is positioned on the air outlet 49′ and only allows fluid flow in the direction from the air chamber 95 to the pressure chamber 50′. As such, when the piston 90 moves in the direction of arrow A, the vacuum force impacts only the air inlet 52′ and not the pressure chamber 50. When the piston 90 moves in the direction of arrow B, the air with the air chamber 95 is driven through the air tube 47′ and into the pressure chamber 50′.

With each stroke of the piston 90, a combination of pressurized liquid and air to enter the pressure chamber 50′. The pressure chamber 50′ is in fluid communication with the outlet tube 27′ of the outlet port 26′. As such, the pressurized liquid/air mixture is delivered to the outlet port 26′ from which it is delivered to the freezing chamber via a tube (not shown). As in the previous embodiment, the outlet flange 80 defines a pressure relief chamber 57′ configured to receive a pressure relief valve (not shown). The pressure relief chamber 57′ defines a seat 58′ and is in fluid communication with the pressure chamber 50′ via relief passage 59′. The position of the pressure relief chamber 57′ along an outer surface of the outlet flange 80 allows for easy removal and cleaning of the pressure relief valve.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A pump assembly comprising:
a pump structure defining a mixture inlet extending to a mixture outlet opening into a receiving chamber and an air inlet extending to an air outlet opening into an air chamber defined between the pump structure and a piston supported on and movable relative to pump structure;
a pressurized fluid tube extending through the pump structure from a pressure inlet in fluid communication with the receiving chamber to a pressure outlet within a pressure chamber which is communication with an outlet port; and
an air tube extending through the pump structure from the air chamber to an air outlet within the pressure chamber;
wherein each stroke of the piston causes pressurized liquid mixture and air to be passed into the pressure chamber and to the outlet port, and wherein a flexible, one-way valve is positioned on each of the mixture outlet, the pressure outlet and the air outlet.

2. The pump assembly according to claim one wherein each of the flexible, one-way valves has a duckbill configuration.

3. The pump assembly according to claim 1 wherein the mixture outlet, the pressure outlet and the air outlet each include a tube portion with a radially extending barb configured to engage an inside surface of each respective flexible, one-way valve.

4. The pump assembly according to claim 1 wherein the mixture outlet, the pressure outlet and the air outlet each include a tube portion and each flexible one-way valve has an open area configured to receive a respective tube portion therein.

5. The pump assembly according to claim 4 wherein each open area has an internal diameter substantially equal to an outer diameter of the respective tube portion.

6. The pump assembly according to claim 4 wherein each open area has an internal depth and each tube has an insertion depth substantially equal to the internal depth.

7. The pump assembly according to claim 1 wherein a check valve is attached to the air inlet external to the pump structure.

8. The pump assembly according to claim 1 wherein a pressure relief chamber extends along an external surface of the pump structure, the pressure relief chamber in fluid communication with the pressure relief chamber via a pressure tube, wherein a pressure relief valve is positioned within the pressure relief chamber and engages the pressure tube.

9. The pump assembly according to claim 1 wherein the pump structure is a unitary structure.

10. The pump assembly according to claim 1 wherein the pump structure is defined by at least two components interconnected to one another.

11. The pump assembly according to claim 10 wherein a gasket is positioned between interconnected components.

12. The pump assembly according to claim 11 wherein a portion of the gasket defines a one-way check valve within the air inlet.

13. The pump assembly according to claim 1 wherein the liquid mixture has solid particles therein.

14. The pump assembly according to claim 1 wherein a housing extends about the piston and a portion of the pump structure.

15. The pump assembly according to claim 14 wherein the housing defines the outlet port.

16. A pump assembly comprising:
a pump structure defining a mixture inlet extending to a mixture outlet opening into a receiving chamber and an air inlet extending to an air outlet opening into an air chamber defined between the pump structure and a piston supported on and movable relative to pump structure;
a pressurized fluid tube extending through the pump structure from a pressure inlet in fluid communication with the receiving chamber to a pressure outlet within a pressure chamber which is communication with an outlet port; and
an air tube extending through the pump structure from the air chamber to an air outlet within the pressure chamber;
wherein each stroke of the piston causes pressurized liquid mixture and air to be passed into the pressure chamber and to the outlet port, and wherein a check valve is attached to the air inlet external to the pump structure.
